(19) United States
(12) Patent Application Publication
(10) Pub. No.: US 2026/0141234 A1
(43) Pub. Date: May 21, 2026

(54) CAUSAL DISCOVERY USING HYPER-RELATIONAL KNOWLEDGE GRAPH LINK PREDICTION

(71) Applicant: Robert Bosch GmbH, Stuttgart (DE)

(72) Inventors: Cory Henson, Pittsburgh, PA (US); Utkarshani Jaimini, West Columbia, SC (US)

(21) Appl. No.: 18/955,246

(22) Filed: Nov. 21, 2024

(51) Int. Cl. G06N 3/08; G06N 3/042

(52) U.S. Cl. CPC G06N 3/08; G06N 3/042

(57) ABSTRACT

Causal discovery is performed using knowledge graph link prediction. Information from a causal network is transformed into a causal knowledge graph according to a mapping, the causal knowledge graph including a plurality of causal links, wherein each causal link includes a cause entity, a causal relation, and an effect entity, with the potential for a mediator. The causal knowledge graph is converted into embeddings, where the embeddings include a latent vector space representation of the causal knowledge graph. The embeddings are trained using a subset of the causal links of the causal knowledge graph. The embeddings are used for causal discovery to predict additional causal links of the causal knowledge graph.

### TECHNICAL FIELD

Aspects of the disclosure generally relate to causal link prediction using a hyper-relational knowledge graph.

### BACKGROUND

A knowledge graph is a graphical data model which captures semantic relationships between entities, where the entities may be events, objects, or concepts. The knowledge graph may be used to capture causality in terms of cause and effect. Such an entity-based representation model enables broader search space by linking a causal entity to relevant effect entities or concepts in the knowledge graph.

### SUMMARY

In one or more illustrative examples, a method for causal discovery using knowledge graph link prediction includes translating information from a causal network into a causal knowledge graph, the causal knowledge graph comprising a plurality of causal links, wherein each of the causal links includes a cause entity, a causal relation, and an effect entity, and at least a subset of the causal links include causal hyper-relational links further connecting the cause entity and the effect entity with an associated qualifier entity as a mediator that is an intermediary in a serial causal connection between the cause entity and the effect entity; converting the causal knowledge graph into embeddings, the embeddings comprising a latent vector space representation of the causal knowledge graph; training the embeddings using the causal links and the causal hyper-relational links of the causal knowledge graph; and using the embeddings for causal discovery to predict additional causal links of the causal knowledge graph.

In one or more illustrative examples, converting the causal knowledge graph into embeddings includes using a StarE graph neural network-based approach, where a varied number of qualifier pairs are configurable as being associated with each of the causal links.

In one or more illustrative examples, the translating is performed conformant to a causal ontology, the causal ontology defining concepts to structure the causal knowledge graph.

In one or more illustrative examples, the translating further includes mapping nodes in the causal network into causal entities in the causal knowledge graph; and mapping edges in the causal network into causal links in the causal knowledge graph.

In one or more illustrative examples, the qualifier entity includes a mediator entity serially between the cause entity and the effect entity, such that the cause entity causes the effect entity and/or the cause entity explains the effect entity.

In one or more illustrative examples, wherein the causal hyper-relational links include qualifier relations, the qualifier relations including one or more of: a hasMediator qualifier relation indicating the presence or absence of a mediator or a hasMediatorType qualifier relation indicating a type of the mediator.

In one or more illustrative examples, the causal discovery includes casual explanation to predict, given an effect entity, the type of the cause entity.

In one or more illustrative examples, the causal discovery includes casual prediction to predict, given a cause entity, the type of the effect entity.

In one or more illustrative examples, a system for causal discovery using knowledge graph link prediction includes one or more hardware computing devices configured to: translate information from a causal network into a causal knowledge graph, the causal knowledge graph comprising a plurality of causal links, wherein each of the causal links includes a cause entity, a causal relation, and an effect entity, and at least a subset of the causal links include causal hyper-relational links further connecting the cause entity and the effect entity with an associated qualifier entity as a mediator that is an intermediary in a serial causal connection between the cause entity and the effect entity; convert the causal knowledge graph into embeddings, the embeddings comprising a latent vector space representation of the causal knowledge graph; train the embeddings using the causal links and the causal hyper-relational links of the causal knowledge graph; and use the embeddings for causal discovery to predict additional causal links of the causal knowledge graph.

In one or more illustrative examples, to convert the causal knowledge graph into embeddings includes to use a StarE graph neural network-based approach, where a varied number of qualifier pairs are configurable as being associated with each of the causal links.

In one or more illustrative examples, to translate information is performed conformant to a causal ontology, wherein the causal ontology defines concepts to structure the causal knowledge graph.

In one or more illustrative examples, to translate information further includes to map nodes in the causal network into causal entities in the causal knowledge graph; and map edges in the causal network into causal links in the causal knowledge graph.

In one or more illustrative examples, the qualifier entity includes, for causal explanation, a mediator entity serially between the effect entity and the cause entity that explains the cause of the effect entity.

In one or more illustrative examples, the qualifier entity includes, for causal prediction, a mediator entity serially between the cause entity and the effect entity that causes the effect entity.

In one or more illustrative examples, the causal hyper-relational links include qualifier relations, the qualifier relations including one or more of: a hasMediator qualifier relation indicating the presence or absence of a mediator and a hasMediatorType qualifier relation indicating the type of the mediator.

In one or more illustrative examples, the causal discovery includes casual explanation to predict, given an effect entity, the type of a cause entity.

In one or more illustrative examples, the causal discovery includes casual prediction to predict, given a cause entity, the type of an effect entity.

In one or more illustrative examples, a non-transitory computer-readable medium includes instructions for causal discovery using knowledge graph link prediction that, when executed by one or more computing devices, cause the one or more computing devices to perform operations including to: translate information from a causal network into a causal knowledge graph, the causal knowledge graph comprising a plurality of causal links, wherein each of the causal links includes a cause entity, a causal relation, and an effect entity, and at least a subset of the causal links include causal hyper-relational links further connecting the cause entity and the effect entity with an associated qualifier entity as a mediator that is an intermediary in a serial causal connection between the cause entity and the effect entity; convert the causal knowledge graph into embeddings, the embeddings comprising a latent vector space representation of the causal knowledge graph; train the embeddings using the causal links and the causal hyper-relational links of the causal knowledge graph; and use the embeddings for causal discovery to predict additional causal links of the causal knowledge graph.

In one or more illustrative examples, to convert the causal knowledge graph into embeddings includes to use a StarE graph neural network-based approach, where a varied number of qualifier pairs are configurable as being associated with each of the causal links.

In one or more illustrative examples, to translate information is performed conformant to a causal ontology, wherein the causal ontology defines concepts to structure the causal knowledge graph.

In one or more illustrative examples, the causal hyper-relational links include qualifier relations, the qualifier relations including one or more of: a hasMediator qualifier relation indicating the presence or absence of a mediator and/or a hasMediatorType qualifier relation indicating the type of the mediator.

In one or more illustrative examples, the qualifier entity includes a mediator entity serially between the cause entity and the effect entity, such that the cause entity causes the effect entity and/or the cause entity explains the effect entity.

### BRIEF DESCRIPTION OF THE DRAWINGS

FIG. 1A illustrates an example serial causal connection where A causes B and eventually B causes C;

FIG. 1B illustrates a serial causal link encoded as a knowledge graph link using resource description format (RDF) format;

FIG. 1C illustrates the causal link as a hyper-relational link where the mediator entity is represented a hyper-relation with the hyper-relation predicate, hasMediator, using RDF-Star format;

FIG. 2A illustrates a flow diagram of the four phases of the disclosed approach to finding missing causal links in an incomplete causal network;

FIG. 2B illustrates an example of causal link prediction including qualifier relations;

FIG. 2C illustrates an example of causal link prediction without qualifier relations;

FIG. 3 illustrates an example reified relation in the context of a CausalKG;

FIG. 4 illustrates an example StarE encoder;

FIG. 5 illustrates an example StarE architecture for a link prediction model;

FIG. 6A illustrates an example CausalKG structure including a subgraph C with causal links with only causal relations;

FIG. 6B illustrates an example CausalKG structure including a subgraph CT with causal links with causal relations and information about entity types;

FIG. 6C illustrates an example CausalKG structure including a subgraph CTP with causal relations, entity type relations, and information about the objects that participate in the causal events;

FIG. 7A illustrates a snapshot of collision events is shown in a video at times t−1, t, and t+1;

FIG. 7B illustrates the causal event graph of the snapshot of FIG. 7A;

FIG. 7C shows the causal and mediator links representation of the causal event in two different CausalKGs;

FIG. 8A illustrates example experimental results of performing causal explanation using subgraph C;

FIG. 8B illustrates example experimental results of performing causal explanation using subgraph CT;

FIG. 8C illustrates example experimental results of performing causal explanation using subgraph CTP;

FIG. 9A illustrates example experimental results of performing causal prediction using subgraph C;

FIG. 9B illustrates example experimental results of performing causal prediction using subgraph CT;

FIG. 9C illustrates example experimental results of performing causal prediction using subgraph CTP;

FIG. 10 illustrates an example process for causal discovery using hyper-relations;

FIG. 11 depicts a schematic diagram of a control system configured to control a robotic assistant based on the causal discovery; and

FIG. 12 illustrates an example manufacturing system for use in anomaly detection and/or generation of synthetic anomalous data.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Causality is traditionally represented using a causal Bayesian network (CBN), where the nodes in the CBN represent events and edges, or links, represent the causal association between two events. Having a complete network with all causal associations is important for many downstream applications. In practice, however, such causal networks are often incomplete with missing causal links. Recent approaches have successfully resolved this issue by encoding the causal network within a triple-based knowledge graph, such as resource description format (RDF), and then using knowledge graph link prediction techniques to find the missing causal links. While this approach works well for simple binary causal links, more complex links, such as mediated causal links, are not supported.

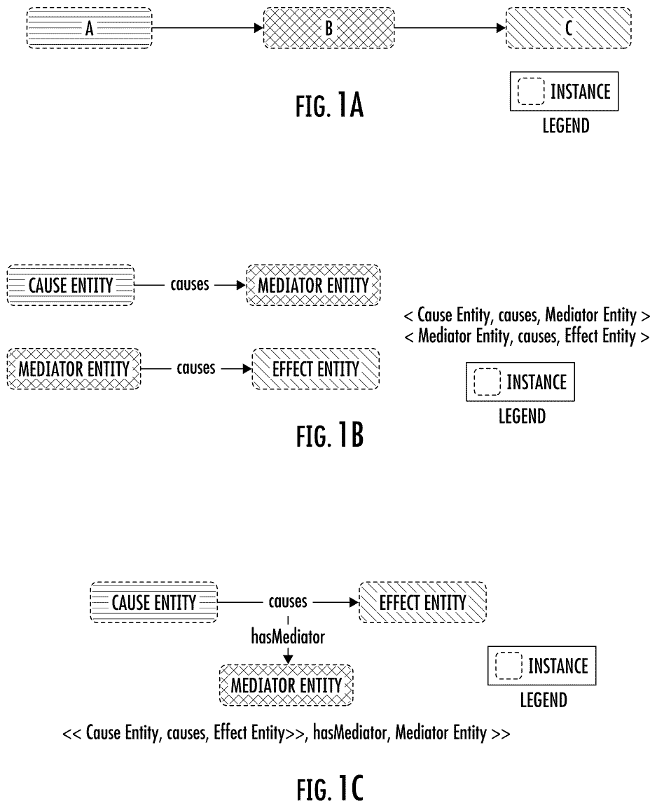

FIGS. 1A-C illustrates examples of the structure of causal connections. FIG. 1A illustrates an example serial causal connection where A causes B and eventually B causes C. FIG. 1B illustrates a serial causal link encoded as a knowledge graph link using RDF format. FIG. 1C illustrates the causal link as a hyper-relational link where the mediator entity is represented as a hyper-relation with the hyper-relation predicate, hasMediator (e.g., total causal effect, natural direct effect, natural indirect effect). The causal link is encoded as a knowledge graph link using RDF-Star format.

Referring to FIG. 1A, a simple binary causal link may be defined such that A causes B. In this case, A may be referred to as the cause and B may be referred to as the effect. Such causal links may also be chained together, where A causes B and then B causes C. In this more complex case, there is a causal link between A and C that is mediated by B. The nodes A and C may be referred to as the cause and effect respectively and the node B may be referred to as a mediator.

While the existing approaches using knowledge graph (KG) link prediction can predict direct binary causal links, e.g., A causes B, they cannot predict the more complex mediated causal links, e.g. A causes C mediated by B.

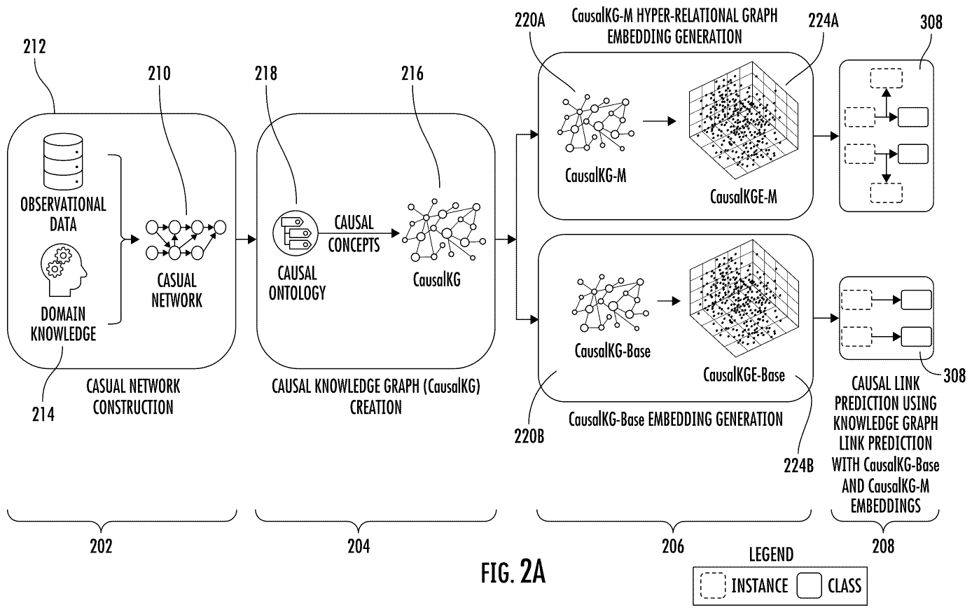

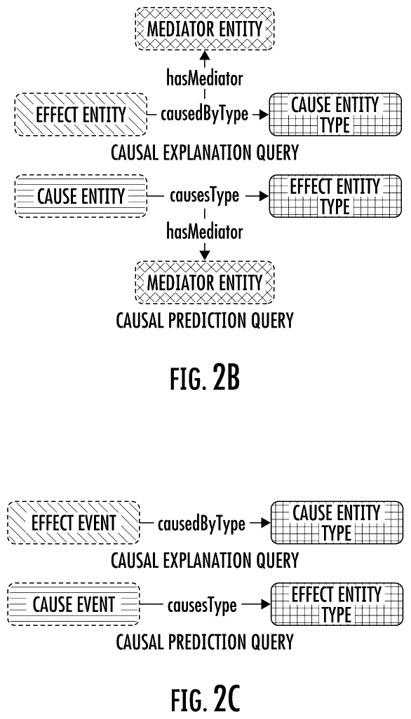

FIG. 2A illustrates a flow diagram of the four phases of the disclosed approach to finding missing causal links 308 in an incomplete causal network. This approach may be referred to as hyper-causal link prediction (HyperCausalLP), which supports and leverages mediated links. This is accomplished through the use of hyper-relational knowledge graphs to represent the complex causal relations. These four primary phases are: causal network construction 202, causal knowledge graph creation 204, embedding generation 206, and causal discovery 208.

The causal network construction 202 may include finding and encoding the known causal relations into a causal network 210. The examples in FIG. 1A-C shows how mediated causal links 308 can be encoded as a hyper-relation. RDF-Star1 may be used to encode these causal links 308. This causal network construction 202 may be performed using observational data 212 and/or using domain knowledge 214. The causal knowledge graph creation 204 may include translating the causal network 210 into a CausalKG 216, conformant to a causal ontology 218.

The embedding generation 206 may include learning KG embedding models 220A, 220B for the CausalKG 216. The hyper-relational KG is then used to train a KG embedding (KGE) model. This may be accomplished with the StarE algorithm which uses a neural network-based message passing framework. Finally, new causal links 308 are predicted with the KGE model. In the approach, the embedding include CausalKG-Base without mediator relations and a hyper-relational graph based embedding CausalKG-M with mediators as hyper-relations.

The causal discovery 208 may include using knowledge graph embeddings for causal discovery 208 tasks. One example of such a task is predicting new causal links 308 in the CausalKG 216. More specifically, two causal tasks are performed: (1) causal explanation, in which the effect event is given and its cause is predicted, and (2) causal prediction, in which the cause event is given and its effect is predicted.

This approach to finding missing causal links 308, with mediators, may be evaluated using a benchmark dataset for causal reasoning, CLEVRER-Humans. The dataset provides a set of causal networks 210 representing collision events in simulated videos. From this set of causal networks, a hyper-relational causal KG is generated, a KG embedding model is trained, and two link prediction operations are performed in the form of causal explanation and causal prediction. The results of this evaluation demonstrate that causal link 308 prediction using a hyper-relational KG embedding model to encode mediators outperforms the baseline approach using standard triple-base KG embedding models without mediators.

The causal link 308 prediction may be formulated as a KG link prediction problem. The following definitions defines the primary concepts, including causal relations 304, causal links 308, causal entities 302, qualifier entities 312, causal hyper-relational links 316, and causal knowledge graphs.

A causal knowledge graph CausalKG is a hyper-relational KG that includes causal knowledge in the form of causal relations 304, and causal entities 302. Let CausalKG=(N, R, E, Ec), where:
N: a set of nodes representing entities;
R: a set of labels representing relations;
E⊆N×R×N: a set of edges representing links between pairs of entities. Each link is a triple <h, r, t>, where h is the head entity, r is the relation, t is the tail entity;
N_{c}⊆N: a set of nodes representing causal entities 302;
R_{c}⊆R: a set of labels representing causal relations 304;
P denotes the power set; and
E_{c}⊆N_{c}×R_{c}×N_{c}×P(Rₘ×Nₘ): a set of edges, representing causal hyper-relational links 316 connecting pairs of causal entities 302.

A causal entity 302, n_{c}∈N_{c}, is an entity that is the head or tail of a causal link 308. There are two types of causal entities 302: cause-entity (n_{cause}) and effect-entity (n_{effect}) such that the cause-entity causes the effect-entity. However, in the case of a hyper-relation link, a causal entity 302 can also be a qualifier entity 312 (nₘ∈Nₘ).

A causal relation 304, r_{c}∈R_{c}, is a relation representing a causal association between entities. There are four types of causal relations 304:
causes (r_{causes}∈R_{c}) is a causal relation 304 from the cause-entity to the effect-entity;
causedBy (r_{causedBy}∈R_{c}) is a causal relation 304 from the effect-entity to the cause-entity; i.e. the inverse of causes;
causesType (r_{causesType}∈R_{c}) is a causal relation 304 from the cause-entity to the type of the effect-entity; and
causedByType (r_{causedByType}∈R_{c}) is a causal relation 304 from the effect-entity to the type of the cause-entity.

A causal link 308, e_{c}∈E_{c}, is an edge in the causalKG 216 connecting a pair of causal entities 302 with a causal relation 304. The causal link 308 is a triple <h_{c}, r_{c}, t_{c}>, where he is the head causal entity 302, r_{c} is the causal relation 304, and t, is the tail causal entity 302.

A qualifier pair 310, q∈Q is a hyper-relation in the causalKG 216 connecting a causal link 308 with its hyper-relation relation-entity pair. Q is a set of qualifier pairs 310 (rₘ, nₘ) with qualifier relation, rₘ, and qualifier entity 312, nₘ.

A qualifier entity 312, nₘ∈Nₘ is a causal entity 302 which is part of the qualifier pair 310. In a given serial causal connection, the qualifier entities 312 (i.e. mediators) are the entities in between the cause-entity and effect-entity connected in a sequence, also known as mediators. In this disclosure, the qualifier entity 312 refers to the mediator in the serial causal connection. In the context of the disclosure, the word qualifier entity 312 and mediator may be used interchangeably.

A qualifier relation 314, rₘ∈Rₘ is a relation representing an association between a causal link 308 and qualifier entities 312 (e.g., a mediator entity). There are two types of qualifier relations 314:
hasMediator (r_{hasMediator}∈Rₘ) is a qualifier relation 314 from the causal link 308 to the mediator-entity; and
hasMediatorType (r_{hasMediatorType}∈Rₘ) is a qualifier relation 314 from the causal link 308 to the type of the mediator-entity.

A causal hyper-relational link 316, e_{c}∈E_{c} is an edge in the causalKG 216 connecting a pair of causal entities 302 with a causal relation 304 and their associated mediators (qualifier entities 312). Each causal hyper-relational link 316 is a tuple <h_{c}, r_{c}, t_{c}, Q>, where h_{c} is the head causal entity 302, r_{c} is the causal relation 304, t, is the tail causal entity 302, Q is a set of qualifier pairs 310 (rₘ, nₘ) with qualifier relation 314, rₘ, and qualifier entity 312, nₘ.

Causal relation 304 extraction is the task of finding new causal links 308 in a CausalKG 216. Given a CausalKG 216, G, this task can be implemented using knowledge graph link prediction. There are two types of causal relation 304 extraction-causal prediction and causal explanation:
Causal prediction: given a cause-entity (n_{cause}∈N_{c}), the causesType relation
(r_{causesType}∈R_{c}), and the qualifier pair 310 (Q), find the type (t) of the associated effect-entity such that <n_{cause}, r_{causesType}, t, Q>∈G holds.
Causal explanation: given an effect-entity (n_{effect}∈N_{c}), the causedByType relation (r_{causedByType}∈R_{c}), and the qualifier pair 310 (Q), find the type (t) of the associated cause-entity such that <n_{effect}, causedByType, t, Q>∈G holds.

Referring back to FIG. 2A, the HyperCausalLP is structured into four primary phases: causal network construction 202 in which known causal relations 304 are found and encoded into a causal network 210, causal KG creation 204 where the causal network 210 is translated into a CausalKG 216, conformant to the hyper-relational causal ontology 218 incorporating the qualifier pairs 310, embedding generation 206 during which hyper-relational KG embeddings 224 are learned for the CausalKG 216, and causal discovery 208 in which new causal links 308 are predicted in the CausalKG 216.

A causal network 210 is a graphical model known as a causal Bayesian network, structured as a directed acyclic graph. In this model, nodes symbolize events, and edges represent the causal links 308 between these events. The network, denoted as CN=(N^{cn}, E^{cn}), comprises nodes N^{cn}, and edges E^{cn}. The direction of each edge in the network indicates the direction of causality. Given a three nodes causal network 210, the causal links 308 can have three different orientation structure: serial, fork, and collider. A serial structure is one where a causal association is traversed in a series, such as the first event is responsible for causing the second event, and the second event is responsible for causing the third event. In the fork structure, the first event is responsible for causing both the second and the third event. In the collider structure, two independent events are together responsible for causing the third event. However, this disclosure focuses on the serial structure as shown in FIG. 1A. The first node is considered a cause-entity, the second node is the mediator-entity, and the third node is the effect-entity.

The process of transforming data from a causal network 210 into a hyper-relational causal knowledge graph (CausalKG 216) involves several straightforward conversions:
N_{cn}→N_{c}: nodes in the causal network 210 become causal entities 302 in the CausalKG 216. The mediator nodes in the causal network 210 becomes mediator entities in the CausalKG 216 which are represented as the qualifier entities 312.
E_(cn)→E_c: edges in the causal network 210 become causal links 308 in the CausalKG 216, of the form <n_{cause}, T_{causes}, n_{effect}, rₘ, nₘ>.

The CausalKG 216 also incorporates other causal relations 304 and qualifier relations 314 such as: causedBy, causesType, causedByType, hasMediator, and hasMediatorType. The CausalKG 216 includes the information from the causal network 210 and is conformant to the causal ontology 218. The causal ontology 218 may be rooted in concepts from causal artificial intelligence (AI), such as causal Bayesian networks and do-calculus. The causal ontology 218 may be used to define the semantics and structure of causal relations 304 and the nodes in the CBN. The ontology may define primary concepts used to structure a CausalKG 216, including the causal entities 302, the causal relations 304, and the mediators.

The CausalKG 216 is used for causal link 308 prediction using KG link prediction. There are two causal link 308 prediction tasks: causal explanation and causal prediction. A goal of causal explanation is to predict the type of a cause-entity which is linked to an effect-entity. A goal of causal prediction is to predict the type of an effect-entity which is linked to a cause-entity. A goal for both the task is not to predict the specific cause-entity (in the case of causal explanation) or effect-entity (in the case of causal prediction) instance but the type of these respective entities.

The cause-entity (in the case of causal explanation) and effect-entity (in the case of causal prediction) are not directly linked with the cause-entity type and effect-entity respectively. They are two-hops away: <n_{effect}, r_{causedBy}, n_{cause}>, <n_{cause}, rdf: type, type> for causal explanation; and <n_{cause}, r_{causes}, n_{effect}>, <n_{effect}, rdf: type, type> for causal prediction. The embedding models make prediction about directly linked entities.

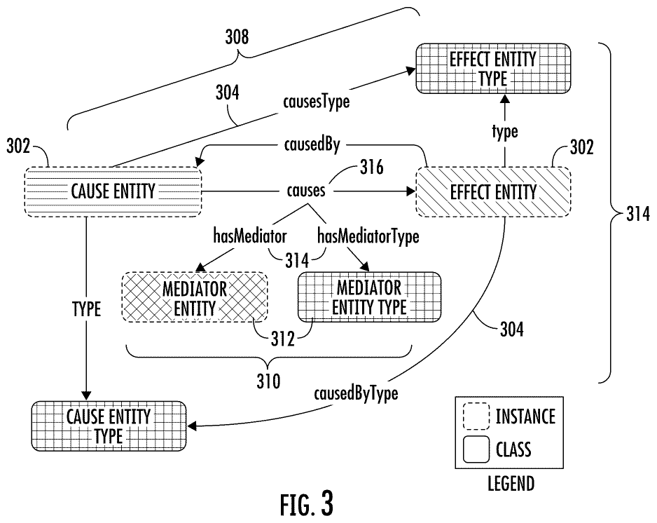

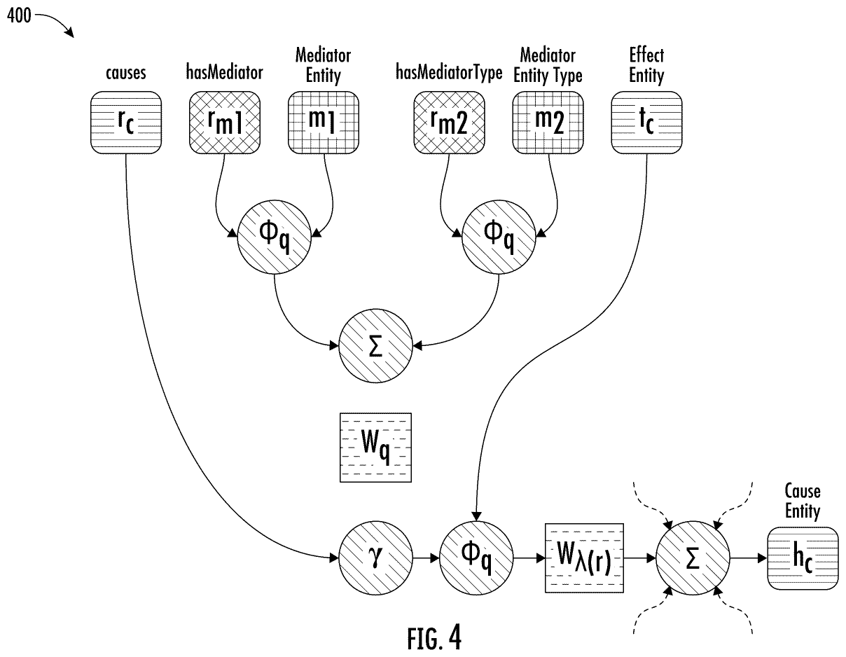

FIG. 3 illustrates an example 300 reified relation in the context of a CausalKG 216. The example 300 shows reified causal relations 304, causesType and causedByType. The causedByType is a reified relation from an effect-entity instance to the type of a cause-entity. The causes Type is a reified relation from a cause-entity instance to the type of an effect-entity. The example 300 also illustrates the two qualifier relations 314 associated with causes relation: hasMediator and hasMediatorType. The qualifier relations 314 are also associated with the causedBy relation which is an inverse of the causes relation. Such an example 300 may be is used for causal prediction: causeType (r_{causesType}∈R_{c}) to add a link connecting a cause-entity with the type of an effect-entity. In another example, it is used for causal explanation: causedByType (r_{causedByType}∈R_{c}) to add a link connecting an effect-entity with the type of a cause-entity. Along with all the above knowledge, the CausalKG 216 also may integrate additional domain knowledge 214 associated with the entities which is not distinctly mentioned in the causal network 210.

Referring back to FIG. 2A, the CausalKG 216 may be converted into a low-dimensional continuous latent vector space representation, which may be referred to as KGE 224. The KGE 224 may be used for downstream tasks such as link prediction, entity classification, triple classification, etc. The Hyper-CausalLP approach may use KG embedding algorithms to generate embedding that may be used for the causal link 308 prediction.

The approach learns two types of KGEs 224 for a CausalKG 216: 1) CausalKGE-Base 224B embedding without mediators (no hyper-relations), and 2) CausalKGE-M 224A embeddings with mediators as hyper-relations (represented using qualifier pairs 310). The CausalKGE-Base 224B embedding may be trained using the causal links 308, ignoring the mediators associated with each link. The CausalKGE-M 224A embedding, on the other hand, may be trained using the causal links 308 with the mediators. The CausalKGE-Base 224B and CausalKGE-M 224A embeddings may be evaluated on the task of causal link 308 prediction using KG link prediction techniques. The CausalKG 216 embeddings for CausalKGE-Base 224B may be generated using KG embedding algorithms available in the Ampligraph library2, in an example.

FIG. 2B illustrates an example of causal link 308 prediction including qualifier relations 314. This may be performed, for example, using the CausalKGE-M 224A embeddings with mediators as hyper-relations. FIG. 2C illustrates an example of causal link 308 prediction without qualifier relations 314. This may be performed, for example, using the CausalKGE-Base 224B embeddings.

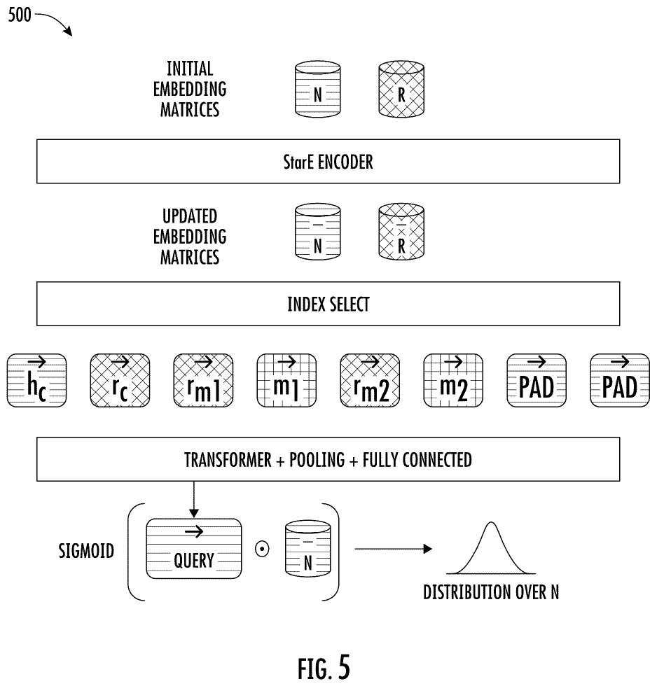

The CausalKGE-M 224A may be generated as a graph neural network based, hyper-relational KGE 224 model, such as StarE. StarE is a graph neural network-based approach. StarE allows a varied number of qualifier pairs 310 to be associated with the causal link 308. StarE combines the causal relation 304 embedding with a fixed-length vector representing the associated qualifier pair 310. StarE incorporates qualifiers pair with the causal link 308 into message passing process. The StarE model includes two parts, the StarE encoder shown in FIG. 4 and the StarE architecture including a Transformer-based decoder as shown in FIG. 5. The StarE encoder and transformer-based decoder may be jointly trained.

FIG. 4 illustrates an example StarE encoder 400. The StarE encoder 400 encodes a hyper-relations for the causal relation. The hyper-relation qualifier pairs (or mediator pairs) are passed through a composition function φq, which are summed together and transformed by weights Wq. The transformed vector is merged with γ and φr. The final node i.e. cause-entity combines messages from all the hyper-relations. As specified in StarE:
φ is a composition function of a node with its respective relation,
W_{λ(r)} is a direction-specific shared parameter for outgoing, incoming, and self-looping relations, and
γ is a function that combines the main relation, (r_{c}) representation with the representation of its qualifiers (Q)

The StarE encoder 400 may be used in KGE 224 models or relational reasoning networks. In an example, r_{c} (the cause) interacts with mediator entities including rₘ₁, rₘ₂, m₁, m₂, where these relationships are processed through various transformations (Φq, Φr) and aggregations (Σ). The model computes a weighted sum or transformation of these intermediary relationships and outputs an encoded representation (h_{c}) of the cause-entity that captures how it relates to the effect-entity (t_{c}) and its mediators. As shown, r_{c} represents the set of causes, rₘ represents the set of mediators, and m represents the set of mediators. Φ(phi) functions refer to transformations of input vectors or embeddings, and the Φq, Φr nodes represent transformation functions or mappings, such as neural network activations or parameterized functions that encode relationships between the entities. Φq may refer to transformations specific to mediators, while Φr may refer to transformations applied after a summation step that aggregates intermediary information. The summation nodes (denoted by Σ) aggregate inputs from the various mediators, which may combine information from different mediator paths to integrate different relational signals before further processing. W_{q} and W_{λ(r)} refer to weights in the neural network which correspond to learnable parameters that adjust the influence of the aggregated information. W_{q} may be applied to the aggregation of mediators, while W_{λ(r)} may influence the cause-entity path. γ represents a gating mechanism or an activation function that modulates the encoded information before being passed on to the final summation and prediction steps.

FIG. 5 illustrates an example StarE architecture 500 for a link prediction model. As shown, the StarE architecture 500 updates the N, R matrices, which are then used to encode the relations in a given query before passing them through the Transformer, Pooling and fully connected layers. The fixed-dimensional output is then compared to N and the result is passed through a Sigmoid function to yield a probability distribution over entities.

The StarE approach initializes two embedding matrices, R (relations) and E (entities). StarE iteratively updates the embedding by message passing across edges in the training set. For the task of link prediction, the query is first linearized and then updated embedding is used to encode the relation and entities. The data is then passed through the transformer. The output of the transformer is averaged to get a fixed-dimensional vector representation of the query. The vector is passed through a fully connected layer, multiplied with the entity and passed through a sigmoid function to obtain probability distribution over all entities. The top n candidate entities for the link prediction query is obtained.

The disclosed approach, HyperCausalLP, formalizes the problem of causal link 308 prediction as a KG link prediction task. The trained CausalKG 216 embedding models, i.e. CausalKGE-Base 224B and CausalKGEM, are used to predict missing causal links 308 between causal entities 302 in the KG. More specifically, HyperCausalLP is used for the task of causal explanation and causal prediction. Causal explanation aims to predict the cause of an effect and causal prediction aims to predict the effect of a cause. For a given causal link 308, causal explanation predicts links of form <n_{effect}, r_{causedByType},?, Q>, and causal prediction predicts links of form <n_{cause}, r_{causesType},?, Q>.

For a given dataset, with causal entities 302, causal relations 304, and mediators associated with the causal links 308 between the entities, HyperCausalLP can be used to create a CausalKG 216, generate and learn a KGE 224. The generated KGE 224 can be used for causal link 308 prediction in the form of causal explanation and causal prediction.

The HyperCausalLP may be evaluated using CLEVRER-Humans, a causal reasoning benchmark dataset. More specifically, the HyperCausalLP hyper-relational graph based causal link 308 prediction approach may be evaluated using KG link prediction task for 1) causal explanation, given an effect-entity predict the type of the cause-entity of the causal link 308 of form <n_{effect}, r_{causedByType},?, Q> and 2) causal prediction, given a cause-entity predict the type of effect-entity of the causal triple of form <n_{cause}, r_{causesType},?, Q> (see FIG. 3). The above evaluation may be demonstrated using a benchmark dataset for causal reasoning, CLEVRER-Humans. This section details the CLEVRER-Humans dataset, data preprocessing steps, creation of a CausalKG 216 from the dataset, experimental set up, evaluation metrics, and description of the evaluation for different CausalKG 216 variations.

An initial step in generating a CLEVRER-Humans CausalKG 216 involves pre-processing the causal event graphs (CEGs). The CEGs serve as a proxy for a causal network 210, and their pre-processing is crucial to ensure they align with the definition of a causal network 210. In a causal network 210, edges represent causal links 308 between nodes. The first step in this process is to remove edges with a score of 1, indicating no causal responsibility between the two nodes. Next, to maintain the structure of a directed acyclic graph, edges that create cycles in the CEGs are removed. Finally, CEGs are excluded if they do not have any remaining causal links 308 or have a depth of less than 2 from the root node to the leaf node. After pre-processing, the CLEVRER-Humans dataset is left with 764 CEGs.

Regarding event extraction, the CLEVRER-Humans dataset features 27 distinct events such as collide, enter, exit, halt, and go. These events may be divided into two categories: binary and singular events. Binary events involve two participating objects and include actions such as collide, bump, hit, bounce, and sideswipe. Singular events involve only one object and include actions such as enter, exit, and stop. Information about the event type and participating objects may be extracted from the node descriptions in the CEG by parsing the CEG JavaScript Object Notation (JSON) files provided by the dataset. To capture the root form of event labels (e.g., collide, hit, push) instead of their verb forms (e.g., collided, hits, pushed), the Berkeley neural semantic parser and the Natural Language Toolkit (NLTK) stem lemmatizer may be used (in an example). Nodes that describe multiple events, such as “The red ball collides with the blue sphere and hits the yellow cylinder” may be removed from the CEG since they describe more than one event. Instead the nodes that describe a single event may be focused on.

Regarding object and object property extraction, in addition to extracting the event type, information may be gathered about the participating objects and their characteristics, including color, shape, and material. Some object characteristics in the dataset may be mislabeled, such as an object being labeled as gold instead of yellow. These mislabeling issues may be identified and the terms may be normalized accordingly.

A CausalKG 216 may be created from CLEVRER-Humans by encoding the causal information within the CEGs in RDF format, adhering to the causal ontology 218. The disclosed approach creates two different KGs as noted above, the CausalKG-Base 220B and the CausalKG-M 220A. The CausalKG-Base 220B may be a simple KG with causal links 308, whereas CausalKG-M 220A is a hyper-relational KG which consist of mediator as hyper-relations (qualifiers). The hyper-relation with the mediator information between two given nodes in the CEG may be encoded using the RDF-star format as discussed herein.

The KG may include causal relationships and, in some examples, also details about events (such as hit, collide, push, etc.), the involved objects, and their attributes. CEGs may serve as graphical representations of events in the videos. To represent information from the CEGs, three ontologies may be used: the causal ontology 218, the scene ontology (prefixed with “so:”), and the semantic sensor network ontology (prefixed with “ssn:”). The causal ontology 218 may be employed for events (as causal entities 302), causal relations 304, and their corresponding causal mediators (i.e., qualifier pairs 310). The scene and sensor ontologies depict additional video information, such as scenes, objects, and object characteristics. Each video may be depicted as a scene (so: Scene) using scene ontology concepts. This includes representing and connecting the events within the scene (using the so: includes relation), the objects involved (using the so: hasParticipant relation), and the object characteristics (using the ssn: hasProperty relation). In total, the CausalKG 216 from CLEVRER-Humans contains >48K links, 5664 entities, 31 entity types, and 10 relations.

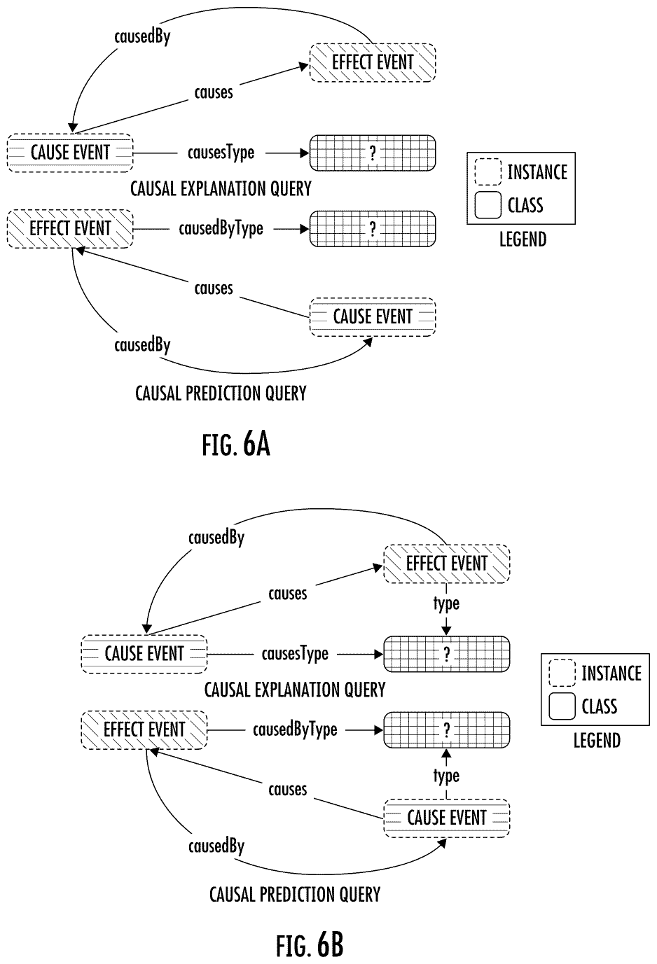

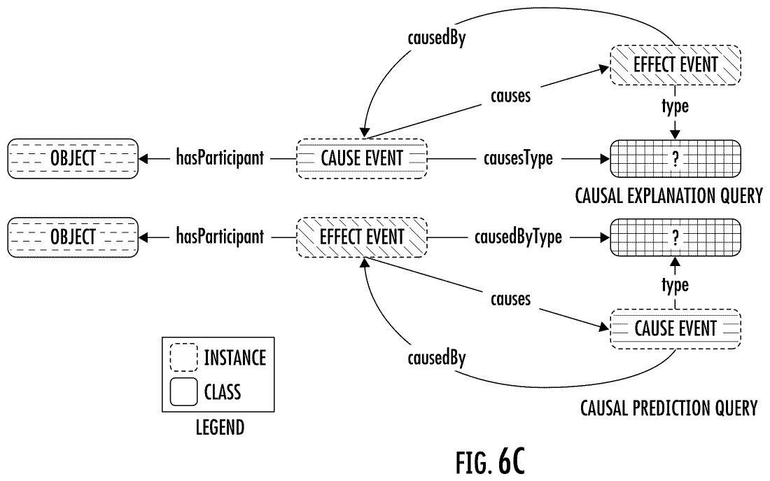

The CausalKGE-Base 224B and CausalKGE-M 224A embeddings may be generated and evaluated on different CLEVRER-Humans CausalKG 216 subgraph structures for the tasks of causal explanation and causal prediction, as illustrated in FIGS. 6A-C. In the case of CausalKG-M and the given subgraph, the hyper-relations (qualifier pairs 310) may be associated with causes, and causedBy causal relation 304 as shown in FIG. 3. Various graph structures may be utilized to assess the performance of HyperCausalLP when different types of information are available in the CausalKG 216. For example, three distinct sub-graph structures may be defined with increasing levels of expressivity (as shown in FIGS. 6A-6C).

FIG. 6A illustrates an example CausalKG 216 structure including a subgraph C with causal links 308 with only causal relations 304. These causal relations 304 may include, for example causes, causedBy, causesType, and causedByType. FIG. 6B illustrates an example CausalKG 216 structure including a subgraph CT with causal links 308 with causal relations 304 and information about entity types. These entity types may include, for example rdf: type. FIG. 6C illustrates an example CausalKG 216 structure including a subgraph CTP with causal relations 304, entity type relations, and information about the objects that participate in the causal events (e.g., hasParticipant). In the case of CausalKGE-M 224A, the hyper-relations (qualifier pair 310) are associated with causes, and causedBy causal relation 304.

The hyper-parameters for each of these graph structures may be optimized for both causal explanation and prediction tasks. The CausalKGE-Base 224B models for each graph structures may be trained on their respective optimized hyper-parameters. The CausalKGE-M 224A model may be trained on the StarE hyper-parameters. The trained CausalKGEs may then be employed for causal link 308 prediction tasks using link prediction methods.

HyperCausalLP may be evaluated using the KG link prediction experimental design set up. For a given set of causal links 308, E_{c}, in CausalKG 216, a set of corrupted links T′ are generated by altering the tail the or head h_{c} of a set of causal links 308, <h_{c}, r_{c}, t_{c}, Q>, with another causal entity 302 in the KG. Such as replacing the head with h_{c}′≠h_{c} results in <h_{c}′, r_{c}, t_{c}, Q> and replacing the tail with t_{c}′=t_{c} results in <h_{c}, r_{c}, t_{c}′, Q>. The model assigns scores to the true link <h_{c}, r_{c}, t_{c}, Q> and corrupted links <h_{c}′, r_{c}, t_{c}′, Q>, <h_{c}, r_{c}, t_{c}′, Q>∈T′. The scores may be sorted to obtain the rank of the true link. The filtered evaluation setting and filtered corrupted links T′ may be used to exclude the links present in the training and validation set. The performance of the HyperCausalLP may be evaluated using two metrics: Mean reciprocal rank (MRR), and Hits@K (Hits@K, where K=1,3,10). MRR is the mean over the reciprocal of individual ranks of the test links. Hits@k is the ratio of test links present among the top k ranked links. The higher values of both the metrics signifies better performance of the model.

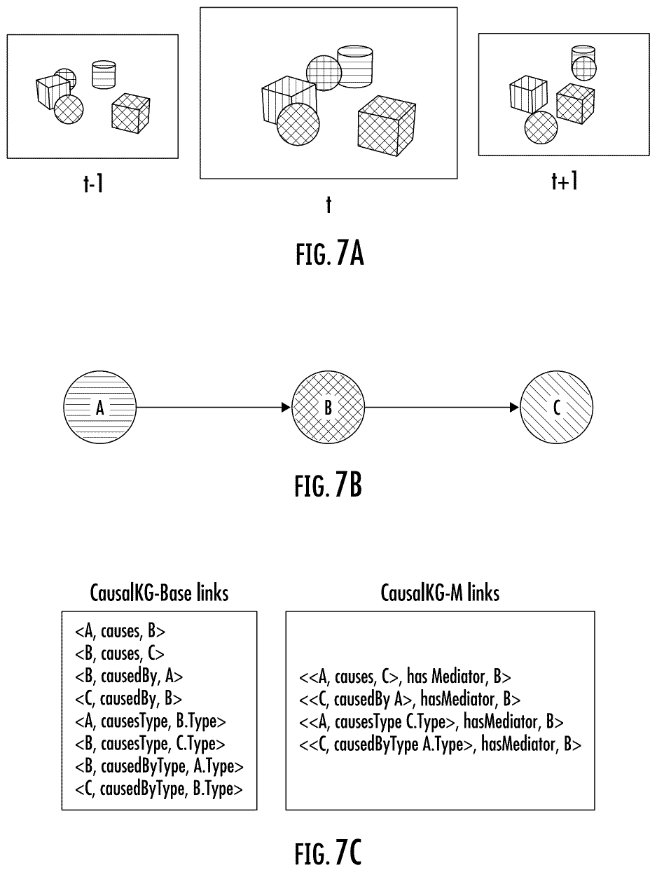

FIG. 7C illustrates an example snapshot of the CausalKG-Base and CausalKG-M representation. As shown in FIG. 7A, a snapshot of collision events is shown in a video at times t−1, t, and t+1 from the CLEVRER-Humans. There are three consecutive collision events that occur, A: the red cube collides with the yellow ball, B: the yellow ball hits the blue cylinder, and C the blue cylinder moves. The A, B, C are causal entities 302. A.Type is Collide, B.Type is Hit, and C.Type is Move. FIG. 7B shows the causal event graph of the snapshot of FIG. 7A. FIG. 7C shows the causal and mediator (qualifier pairs 310) links representation in the two different CausalKG 216.

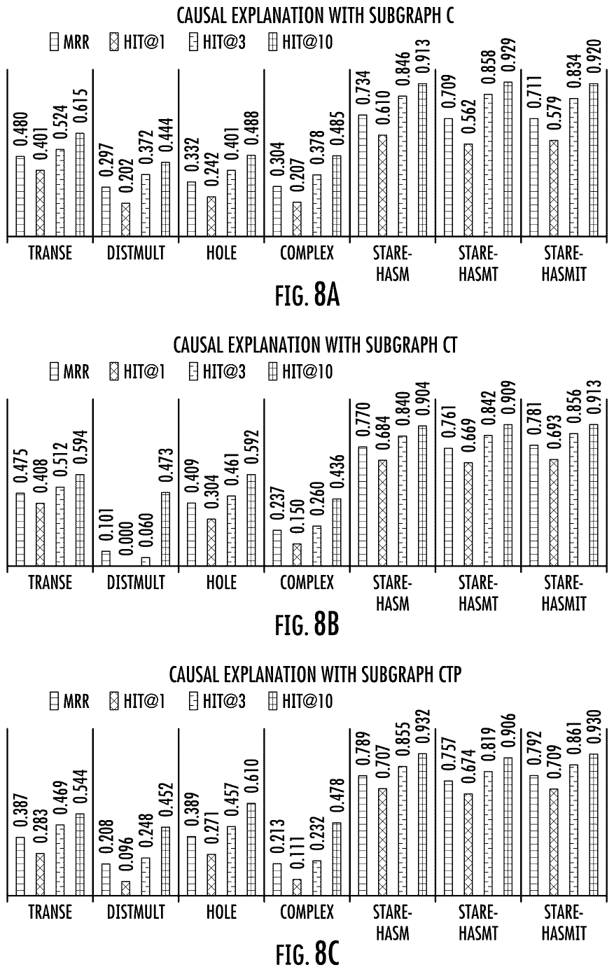

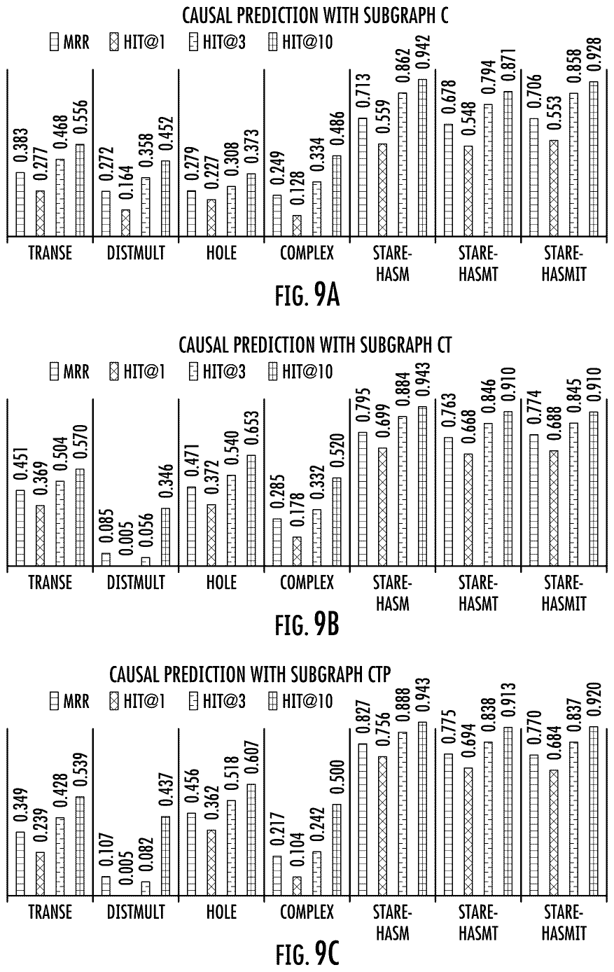

FIG. 8A-8C collectively illustrate example experimental results of the CausalKGE-M 224A and the CausalKGE-Base 224B for performing causal explanation. FIG. 9A-9C collectively illustrates example experimental results of the CausalKGE-M 224A and the CausalKGE-Base 224B for performing causal prediction. More specifically, FIGS. 8A-8C and 9A-9C illustrate MRR and Hit@K (k=1,3,10) for five KGE 224 models evaluated on the different CausalKG 216 subgraphs. These include the C subgraph as shown in FIG. 6A, the CT subgraph as shown in FIG. 6B, and the CTP subgraph as shown in FIG. 6C.

In these results, HyperCausalLP was evaluated on CausalKG 216 generated from the CLEVRER-Humans dataset for causal link 308 prediction. The approach was evaluated on CausalKG-M with StarE on the three different CausalKG 216 subgraphs C, CT, and CTP with different hyper-relations:
CausalKG-HasMediator: hasMediator as the qualifier relation 314
CausalKG-HasMediatorType: hasMediatorType as the qualifier relation 314
CausalKG-HasMediatorInstanceType: both hasMediator and hasMediatorType as qualifier relation 314

The results (i.e., MRR, HitK) shows a significant increase in the performance of CausalKGE-M 224A over CausalKGE-Base 224B, the baseline models with no hyper-relations (or mediator information) and just links. The CausalKGE-Base 224B was evaluated with four KGE 224 models-TransE, DistMult, HolE, and ComplEx. The incorporation of additional knowledge (i.e., CT, CTP) in the CausalKGE-M 224A shows improved performance over the simpler C subgraph.

The addition of more knowledge improves the KG link prediction performance for both the task of causal explanation and causal prediction. The MRR scores of CausalKGE-M 224A with hasMediator when enriched with additional knowledge for causal prediction, i.e., CTP, outperforms C by 13.77%. The MRR scores of CausalKGE-M 224A with hasMediatorType when enriched with additional knowledge for causal prediction, i.e., CTP, outperforms C by 12.55%. The MRR scores of CausalKGE-M 224A with both hasMediator and hasMediatorType when enriched with additional knowledge for causal prediction, i.e., CTP, outperforms C by 8.36%. The MRR scores of CausalKGE-M 224A with hasMediator when enriched with additional knowledge for causal explanation, i.e., CTP, outperforms C by 7.04%. The MRR scores of CausalKGE-M 224A with hasMediatorType when enriched with additional knowledge for causal explanation, i.e., CTP, outperforms C by 6.28%. The MRR scores of CausalKGE-M 224A with both hasMediator and hasMediatorType when enriched with additional knowledge for causal explanation, i.e., CTP, outperforms C by 10.13%. The incorporating of the mediators with causal links 308 provides an additional knowledge which is crucial for the causal link 308 prediction task. The hyper-relation, hasMediator, performs the best compared to other hyper-relations, hasMediatorType, and considering both hasMediator and hasMediatorType together. The hyper-relations based KG performs better with more number of qualifiers. We successfully demonstrated the knowledge incorporated in the hyper-relations (qualifies) significantly improves the causal link 308 prediction.

Thus, an approach is disclosed to finding missing causal link 308 in an incomplete causal network 210. The disclosed approved incorporates the mediator information from the CBN as a hyper-relation in the KG. The KGE 224 models trained with qualifier (mediator, or hyper-relations) outperform all baseline KGE 224 metrics without qualifiers. The results demonstrate that an effective fusion of causal links 308 with qualifier (mediator, or hyper-relations) in a KG can facilitate the completion of incomplete causal network 210.

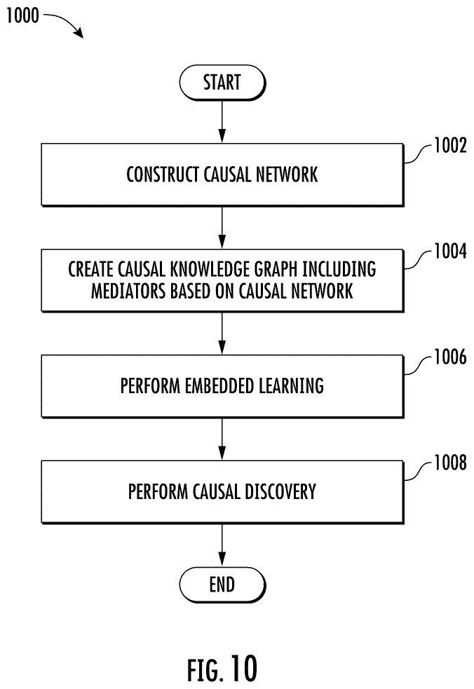

FIG. 10 illustrates an example process 1000 for causal discovery using hyper-relations. The process 1000 may be implement the disclosed approach to causal discovery using knowledge graph link prediction addresses a crucial gap in the state-of-the-art by considering mediator information along with a causal links 308. Using the process 1000, the KGE models trained with mediator information may be seen to outperform baseline KGE metrics without mediator information. The results demonstrate that knowledge incorporated in the hyper-relations significantly improves the causal link 308 prediction.

At operation 1002, causal network construction 202 is performed. The causal network construction 202 may include finding and encoding the known causal relations into a causal network 210. This causal network construction 202 may be performed using observational data 212 and/or using domain knowledge 214.

At operation 1004, causal knowledge graph creation 204 is performed. The causal knowledge graph creation 204 may include translating the causal network 210 into a CausalKG 216, conformant to a causal ontology 218. The CausalKG 216 may include a plurality of causal links, each of the causal links 308 includes a cause entity, a causal relation, and an effect entity. In an example, information from the causal network 210 may be translated into the CausalKG 216 according to a mapping. The mapping may include mapping nodes in the causal network 210 into causal entities 302 in the CausalKG 216 and mapping edges in the causal network 210 into causal links 308 in the CausalKG 216.

At operation 1006, embedding learning 206 is performed. The embedding learning 206 may include learning KG embedding models 220A, 220B for the CausalKG 216 using the train set, and evaluating the training using the test set. This may be performed in two different approaches. In a first approach, CausalKGE-Base 224B is generated using embedding without mediators (no hyper-relations). The CausalKGE-Base 224B embedding may be trained using the causal links 308, ignoring the mediators associated with each link. In a second approach the CausalKGE-M 224A is generated using embeddings with mediators as hyper-relations (represented using qualifier pairs 310). The CausalKGE-M 224A embedding may be trained using the causal links 308 with the mediators. The CausalKGE-Base 224B and CausalKGE-M 224A embeddings may be evaluated on the task of causal link 308 prediction using KG link prediction techniques. The CausalKG 216 embeddings for CausalKGE-Base 224B may be generated using KG embedding algorithms available in the Ampligraph library2, in an example. The CausalKGE-M 224A may be generated as a graph neural network based, hyper-relational KGE 224 model, such as StarE. In many examples, the application of the qualifier pairs 310 from the causal network 210 outperforms baseline KGE metrics without being trained on the hyper-relations.

At operation 1008, causal discovery 208 is performed. The causal discovery 206 may include using the knowledge graph embeddings 224A, 224B for causal discovery tasks. One example of such a task is predicting new causal links 308 in the CausalKG 216. In some examples, the causal discovery 206 includes casual explanation to predict, given an effect entity and a type of a cause entity In some examples, the causal discovery 206 includes casual prediction to predict, given a cause entity abd a type of an effect entity. After operation 1008, the process 1000 ends.

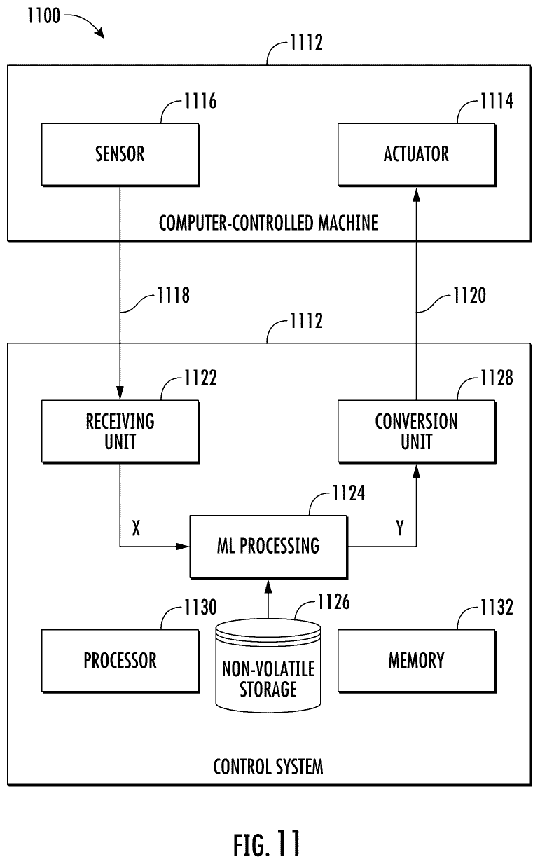

FIG. 11 depicts a schematic diagram of an interaction between a computer-controlled machine 1102 and a control system 1112. The computer-controlled machine 1102 may implement aspects of the causal discovery 208 and use of the predicted causal information. Referring to FIG. 10, and with reference to FIGS. 1A-9C, the approaches discussed herein may be performed in the context of such a computer-controlled machine 1102 and control system 1112. The computer-controlled machine 1102 includes actuator 1114 and sensor 1116. Actuator 1114 may include one or more actuators and sensor 1116 may include one or more sensors. Sensor 1116 is configured to sense a condition of computer-controlled machine 1102. Sensor 1116 may be configured to encode the sensed condition into sensor signals 1118 and to transmit sensor signals 1118 to control system 1112. Non-limiting examples of sensor 1116 include video, radar, LiDAR, ultrasonic and motion sensors. In one embodiment, sensor 1116 is an optical sensor configured to sense optical images of an environment proximate to computer-controlled machine 1102.

Control system 1112 is configured to receive sensor signals 1118 from computer-controlled machine 1102. As set forth below, control system 1112 may be further configured to compute actuator control commands 1120 depending on the sensor signals 1118 and to transmit actuator control commands 1120 to actuator 1114 of computer-controlled machine 1102.

As shown in FIG. 11, control system 1112 includes receiving unit 1122. Receiving unit 1122 may be configured to receive sensor signals 1118 from sensor 1116 and to transform sensor signals 1118 into input signals X. In an alternative embodiment, sensor signals 1118 are received directly as input signals X without receiving unit 1122. Each input signal x may be a portion of each sensor signal 1118. Receiving unit 1122 may be configured to process each sensor signal 1118 to product each input signal x. Input signal x may include data corresponding to an image recorded by sensor 1116.

Control system 1112 includes machine learning (ML) processing 1124. ML processing 1124 may be configured to learn, classify, infer, generate, etc. using one or more models such as those described in detail above. In an example, ML processing 1124 is configured to determine output signals Y from input signals X. Each output signal y includes information that assigns one or more labels to each input signal X. ML processing 1124 may transmit output signals Y to conversion unit 1128. Conversion unit 1128 is configured to convert output signals Y into actuator control commands 1120. Control system 1112 is configured to transmit actuator control commands 1120 to actuator 1114, which is configured to actuate computer-controlled machine 1102 in response to actuator control commands 1120. In another embodiment, actuator 1114 is configured to actuate computer-controlled machine 1102 based directly on output signals Y.

Upon receipt of actuator control commands 1120 by actuator 1114, actuator 1114 is configured to execute an action corresponding to the related actuator control command 1120. Actuator 1114 may include a control logic configured to transform actuator control commands 1120 into a second actuator control command 1120, which is utilized to control actuator 1114. In one or more embodiments, actuator control commands 1120 may be utilized to control a display instead of or in addition to an actuator 1114.

In another embodiment, control system 1112 includes sensor 1116 instead of or in addition to computer-controlled machine 1102 including sensor 1116. Control system 1112 may also include actuator 1114 instead of or in addition to computer-controlled machine 1102 including actuator 1114.

As shown in FIG. 11, control system 1112 also includes processor 1130 and memory 1132. Processor 1130 may include one or more processors. Memory 1132 may include one or more memory devices. The causal hyper-relation links determined by one or more embodiments may be implemented by control system 1112, which includes non-volatile storage 1126, processor 1130 and memory 1132.

Non-volatile storage 1126 may include one or more persistent data storage devices such as a hard drive, optical drive, tape drive, non-volatile solid-state device, cloud storage or any other device capable of persistently storing information. Processor 1130 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 1132. Memory 1132 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 1130 may be configured to read into memory 1132 and execute computer-executable instructions residing in non-volatile storage 1126 and embodying one or more ML algorithms and/or methodologies of one or more embodiments. Non-volatile storage 1126 may include one or more operating systems and applications. Non-volatile storage 1126 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 1130, the computer-executable instructions of non-volatile storage 1126 may cause control system 1112 to implement one or more of the ML algorithms and/or methodologies as disclosed herein. Non-volatile storage 1126 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

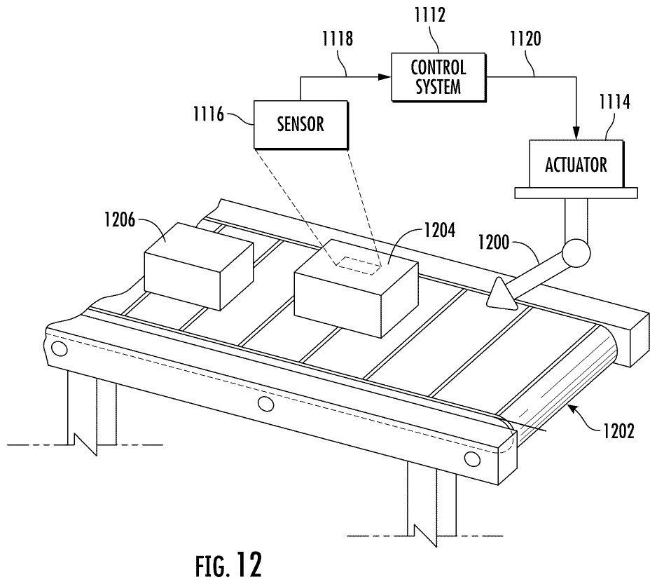

FIG. 12 illustrates an example manufacturing system 1200 for use in anomaly detection and/or generation of synthetic anomalous data. The system 1200 may be configured to control a manufacturing machine 1202, such as a punch cutter, a cutter or a gun drill, etc., such as part of a production line.

The system 1200 may be configured to control an actuator 1114, which is configured to control the manufacturing machine 1202. A sensor 1116 of the system 1200 may be configured to capture one or more properties of a manufactured product 1204. ML processing 1124 may be configured to determine a state of the manufactured product 1204 from one or more of the captured properties. An actuator 1114 may be configured to control the system 1200 (e.g., a manufacturing machine) depending on the determined state of the manufactured product 1204 for a subsequent manufacturing step of the manufactured product 1204. In particular, the actuator 1114 may be configured to control functions of system 1200 (e.g., the manufacturing machine) on subsequent manufactured product 1206 of the system 1200 (e.g., the manufacturing machine) depending on the determined state of the manufactured product 1204.

For example, the system 1200 may utilize the CausalKG 216 to predict reasons for issues in the manufacturing system 1200, such as what issue was causedBy (e.g. causedByType). Or, the system 1200 may utilize the CausalKG 216 to predict outcomes that should be addressed, such as that sensed input may cause an issue, e.g., causesType.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as read-only memory (ROM) devices and information alterably stored on writeable storage media such as floppy disks, magnetic tapes, compact discs (CDs), RAM devices, and other magnetic and optical media. The processes, methods, or algorithms can also be implemented in a software executable object. Alternatively, the processes, methods, or algorithms can be embodied in whole or in part using suitable hardware components, such as ASICs, FPGAs, state machines, controllers or other hardware components or devices, or a combination of hardware, software and firmware components.

The causal discovery of one or more embodiments predicts causal links between physical objects or components. Such causal links between physical objects or components may be dynamic and/or static interactions. Such causal links between physical objects or components may be mechanical, electrical, and/or chemical interactions. For example, and not by way of limiting the applicable physical objects or components, the physical objects or components may be the cubes and balls described in connection with FIG. 7A and the causal links may be dynamic mechanical interactions between the cubes and balls. As another non-limiting example, the physical object or components may be manufacturing machine 1202 and manufactured product 1204 and the causal links may be mechanical interactions between these components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for causal discovery using knowledge graph link prediction, comprising:
translating information from a causal network into a causal knowledge graph, the causal knowledge graph comprising a plurality of causal links, wherein each of the causal links includes a cause entity, a causal relation, and an effect entity, and at least a subset of the causal links include causal hyper-relational links further connecting the cause entity and the effect entity with an associated qualifier entity as a mediator that is an intermediary in a serial causal connection between the cause entity and the effect entity;
converting the causal knowledge graph into embeddings, the embeddings comprising a latent vector space representation of the causal knowledge graph;
training the embeddings using the causal links and the causal hyper-relational links of the causal knowledge graph; and
using the embeddings for causal discovery to predict additional causal links of the causal knowledge graph.

2. The method of claim 1, wherein converting the causal knowledge graph into embeddings includes using a StarE graph neural network-based approach, where a varied number of qualifier pairs are configurable as being associated with each of the causal links.

3. The method of claim 1, wherein the translating is performed conformant to a causal ontology, the causal ontology defining concepts to structure the causal knowledge graph.

4. The method of claim 1, wherein the translating further includes:
mapping nodes in the causal network into causal entities in the causal knowledge graph; and
mapping edges in the causal network into causal links in the causal knowledge graph.

5. The method of claim 4, wherein the qualifier entity includes a mediator entity serially between the cause entity and the effect entity, such that the cause entity causes the effect entity and/or the cause entity explains the effect entity.

6. The method of claim 1, wherein the causal hyper-relational links include qualifier relations, the qualifier relations including one or more of: a hasMediator qualifier relation indicating the presence or absence of a mediator and/or a hasMediatorType qualifier relation indicating the type of the mediator.

7. The method of claim 1, wherein the causal discovery includes casual explanation to predict, given an effect entity, the type of the cause entity.

8. The method of claim 1, wherein the causal discovery includes casual prediction to predict, given a cause entity, the type of the effect entity.

9. A system for causal discovery using knowledge graph link prediction, comprising:
one or more hardware computing devices configured to:
translate information from a causal network into a causal knowledge graph, the causal knowledge graph comprising a plurality of causal links, wherein each of the causal links includes a cause entity, a causal relation, and an effect entity, and at least a subset of the causal links include causal hyper-relational links further connecting the cause entity and the effect entity with an associated qualifier entity as a mediator that is an intermediary in a serial causal connection between the cause entity and the effect entity;
convert the causal knowledge graph into embeddings, the embeddings comprising a latent vector space representation of the causal knowledge graph;
train the embeddings using the causal links and the causal hyper-relational links of the causal knowledge graph; and
use the embeddings for causal discovery to predict additional causal links of the causal knowledge graph.

10. The system of claim 9, wherein to convert the causal knowledge graph into embeddings includes to use a StarE graph neural network-based approach, where a varied number of qualifier pairs are configurable as being associated with each of the causal links.

11. The system of claim 9, wherein to translate information is performed conformant to a causal ontology, wherein the causal ontology defines concepts to structure the causal knowledge graph.

12. The system of claim 9, wherein to translate information further includes to:
map nodes in the causal network into causal entities in the causal knowledge graph; and
map edges in the causal network into causal links in the causal knowledge graph.

13. The system of claim 12, wherein the qualifier entity includes a mediator entity serially between the cause entity and the effect entity, such that the cause entity causes the effect entity and/or the cause entity explains the effect entity.

14. The system of claim 9, wherein the causal hyper-relational links include qualifier relations, the qualifier relations including one or more of: a hasMediator qualifier relation indicating the presence or absence of a mediator and/or a hasMediatorType qualifier relation indicating the type of the mediator.

15. The system of claim 9, wherein the qualifier entity includes a mediator entity serially between the cause entity and the effect entity, such that the cause entity causes the effect entity and/or the cause entity explains the effect entity.

16. A non-transitory computer-readable medium comprising instructions for causal discovery using knowledge graph link prediction that, when executed by one or more computing devices, cause the one or more computing devices to perform operations including to:
translate information from a causal network into a causal knowledge graph, the causal knowledge graph comprising a plurality of causal links, wherein each of the causal links includes a cause entity, a causal relation, and an effect entity, and at least a subset of the causal links include causal hyper-relational links further connecting the cause entity and the effect entity with an associated qualifier entity as a mediator that is an intermediary in a serial causal connection between the cause entity and the effect entity;
convert the causal knowledge graph into embeddings, the embeddings comprising a latent vector space representation of the causal knowledge graph;
train the embeddings using the causal links and the causal hyper-relational links of the causal knowledge graph; and
use the embeddings for causal discovery to predict additional causal links of the causal knowledge graph.

17. The medium of claim 16, wherein to convert the causal knowledge graph into embeddings includes to use a StarE graph neural network-based approach, where a varied number of qualifier pairs are configurable as being associated with each of the causal links.

18. The medium of claim 16, wherein to translate information is performed conformant to a causal ontology, wherein the causal ontology defines concepts to structure the causal knowledge graph.

19. The medium of claim 16, wherein the causal hyper-relational links include qualifier relations, the qualifier relations including one or more of: a hasMediator qualifier relation indicating the presence or absence of a mediator and/or a hasMediatorType qualifier relation indicating the type of the mediator.

20. The medium of claim 16, wherein the qualifier entity includes a mediator entity serially between the cause entity and the effect entity, such that the cause entity causes the effect entity and/or the cause entity explains the effect entity.
